(19) United States
(12) Patent Application Publication
(10) Pub. No.: US 2025/0178634 A1
(43) Pub. Date: Jun. 5, 2025

(54) VEHICLE EMERGENCY RESCUE METHOD, ELECTRONIC DEVICE, AND NON-TRANSITORY STORAGE MEDIUM

(71) Applicant: HON HAI PRECISION INDUSTRY CO., LTD., New Taipei (TW)

(72) Inventor: WAN-CHIEH YU, New Taipei (TW)

(21) Appl. No.: 18/894,306

(22) Filed: Sep. 24, 2024

(30) Foreign Application Priority Data
Nov. 30, 2023 (CN) 202311641634.0

(51) Int. Cl. B60W 50/16; B60W 50/02; B60W 50/14

(52) U.S. Cl. CPC B60W 50/16; B60W 50/0205; B60W 2050/021; B60W 2050/143; B60W 2050/146

(57) ABSTRACT

A vehicle emergency rescue method includes: detecting whether a vehicle meets a preset abnormal accident condition; determining one or more abnormal state types of the vehicle, when the vehicle meets the preset abnormal accident condition; determining an objective rescue plan matched the one or more abnormal state types of the vehicle; and controlling at least one acoustic reminder device to play the objective rescue plan and at least one visual reminder device to display the objective rescue plan. An electronic device and a non-transitory storage medium are also disclosed.

### FIELD

The subject matter herein generally relates to the field of vehicle safety.

### BACKGROUND

As intelligent technology of vehicles continues to develop, vehicles are configured to have more intelligent functions to enhance user's experience. Some vehicles are equipped with emergency rescue functions to improve efficiency of rescue.

For example, when a vehicle has an accident, passengers can manually trigger the emergency rescue functions to achieve self-rescue. However, the passengers are often frightened and unable to make right judgments to activate the emergency rescue functions. Therefore, emergency rescues are inefficient, and the user's experience is generally poor.

### BRIEF DESCRIPTION OF THE DRAWINGS

Implementations of the present disclosure will now be described, by way of embodiments, with reference to the attached figures.

FIG. 1 is a flowchart illustrating a first embodiment of a vehicle emergency rescue method according to the present disclosure.

FIG. 2 is a flowchart illustrating a second embodiment of a vehicle emergency rescue method according to the present disclosure.

FIG. 3 is a flowchart illustrating a third embodiment of a vehicle emergency rescue method according to the present disclosure.

FIG. 4 is a flowchart illustrating a fourth embodiment of a vehicle emergency rescue method according to the present disclosure.

FIG. 5 is a flowchart illustrating a fifth embodiment of a vehicle emergency rescue method according to the present disclosure.

FIG. 6 is a diagram showing modules in an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to,” it specifically indicates open-ended inclusion or membership in the so-described combination, group, series, and the like.

### A First Embodiment

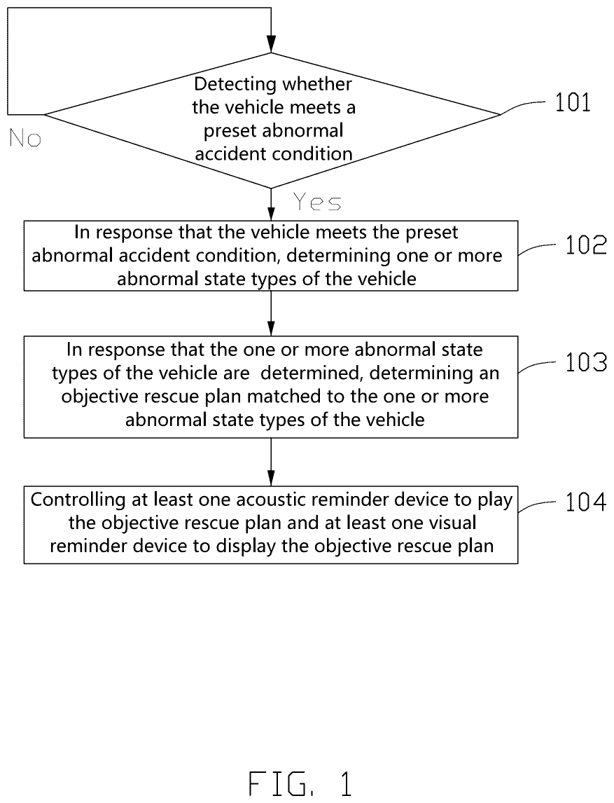

FIG. 1 illustrates one exemplary embodiment of a vehicle emergency rescue method. The flowchart presents an exemplary embodiment of the method. The exemplary method is provided by way of example, as there are a variety of ways to carry out the method. Each block shown in FIG. 1 may represent one or more processes, methods, or subroutines, carried out in the example method. Furthermore, the illustrated order of blocks is illustrative only and the order of the blocks can change. Additional blocks can be added, or fewer blocks may be utilized, without departing from this disclosure.

In block S101, it is detected whether a vehicle meets a preset abnormal accident condition.

In one embodiment, the vehicle is equipped with a variety of types of sensors. For example, the sensors can detect whether the vehicle is impacted. The vehicle is equipped with one or more impact detection sensors which can detect whether the vehicle occurs an accident, according to an impact force on the vehicle. If the impact force on the vehicle is larger than a preset value, it is determined that the vehicle has had an accident.

In one embodiment, the vehicle can also be equipped with other types of sensors, such as temperature sensors and gyroscope sensors. The temperature sensors can detect whether a temperature in the vehicle is abnormal, the gyroscope sensors can detect whether the vehicle is in a balance state. Subsequent embodiments will illustrate how to detect whether the vehicle meets the preset abnormal accident condition.

In one embodiment, the sensors installed on the vehicle can detect whether the vehicle meets the preset abnormal accident condition, and the cost of emergency rescue for the vehicle can be reduced.

In block S102, one or more abnormal state types of the vehicle are determined, in response to the vehicle meeting the preset abnormal accident condition.

In one embodiment, the abnormal state types may include at least one or more of abnormal vehicle door state, abnormal vehicle body balance, abnormal temperature in the vehicle, and abnormal gas in the vehicle.

The subsequent embodiments will illustrate how to determine the one or more abnormal state types of the vehicle.

In block S103, an objective rescue plan matched to the one or more abnormal state types of the vehicle are determined, in response to the one or more abnormal state types of the vehicle being determined.

In one embodiment, the vehicle is provided with a vehicle-mounted system. The vehicle-mounted system stores many objective rescue plans. Each objective rescue plan corresponds to one abnormal state type. After the vehicle-mounted system determines the one or more abnormal state types of the vehicle, the vehicle-mounted system finds the one or more objective rescue plans matched to the one or more abnormal state types of the vehicle.

For example, the objective rescue plans include a rescue plan A, a rescue plan B, a rescue plan C, and a rescue plan D. The abnormal vehicle door state matches with the rescue plan A, the abnormal vehicle body balance matches with the rescue plan B, the abnormal temperature in the vehicle matches with the rescue plan C, and the abnormal gas in the vehicle matches with the rescue plan D. When the vehicle-mounted system determines that the current abnormal state of the vehicle is the abnormal vehicle door condition, the objective rescue plan is the rescue plan A.

In block S104, at least one acoustic reminder device is controlled playing the objective rescue plan and at least one visual reminder device is controlled displaying the objective rescue plan.

In some embodiments, the at least one acoustic reminder device can be a loudspeaker mounted on the vehicle, the at least one visual reminder device can be a vehicle display screen. The loudspeaker plays the objective rescue plan, and the vehicle display screen displays the objective rescue plan.

In one embodiment, the at least one optical reminder device and the at least one tactile reminder device are controlled performing the objective reminder action, when the vehicle meets the preset abnormal accident condition.

In other embodiments, the at least one optical reminder device or the at least one tactile reminder device is controlled performing the objective reminder action, when the vehicle meets the preset abnormal accident condition. The at least one optical reminder device can be an LED light, the at least one tactile reminder device can be a seat vibration reminder device.

In one embodiment, when the vehicle-mounted system detects that the vehicle meets the preset abnormal accident condition, the vehicle-mounted system sends distress information and actual location of the vehicle to one or more rescue platforms. The one or more rescue platforms can be the police or a hospital ambulance center.

In some embodiments, the at least one acoustic reminder device can also be a buzzer mounted on the vehicle, when the vehicle-mounted system detects that the vehicle meets the preset abnormal accident condition, the vehicle-mounted system controls the buzzer to play a warning sound, and people near the vehicle can rescue the passengers in the vehicle after hearing the warning sound.

In one embodiment, the vehicle-mounted system can choose different rescue plans according to the different types of the abnormal state of the vehicle and severity of damage to the vehicle.

For example, the vehicle is in different abnormal state types. When the abnormal state type of the vehicle is the abnormal temperature in the vehicle, it indicates that the battery of the vehicle is overheating and starts to fire at this time. The vehicle-mounted system will quickly send the distress information and the actual location of the vehicle to one hospital ambulance center, and reminds the passengers to leave the vehicle quickly through the seat vibration reminder device and the loudspeaker.

When the abnormal state type of the vehicle is the abnormal vehicle body balance and the abnormal vehicle door states, it indicates that the vehicle falls into water and the vehicle doors cannot be opened at this time. The vehicle-mounted system will quickly send the distress information and the actual location of the vehicle to the police, and the LED lights indicate broken window locations, and the loudspeaker plays placements of a broken window hammer and using method of the broken window hammer, the passengers can get out of trouble in time, and the buzzer plays the warning sound.

For example, the vehicle is in the same abnormal state type, and the vehicle suffered varying degrees of damage. When the abnormal state type of the vehicle is the abnormal vehicle door state, and the impact force on the vehicle is detected to be larger than 20 kg, the vehicle is more seriously damaged at this time. The vehicle is configured to a Save Our Ship (SOS) rescue system. The vehicle-mounted system automatically triggers the SOS rescue system, and sends the distress information to the police, the hospital ambulance center and other rescue platforms. The vehicle-mounted system also provides the accurate location of the accident, the number of the passengers in the vehicle and damage information about the vehicle. The LED lights indicate the broken window locations, and the loudspeaker plays the placement of the broken window hammer and the using method of the broken window hammer, the passengers can get out of trouble in time, and the buzzer plays the warning sound.

When the abnormal state type of the vehicle is the abnormal vehicle door state, and the impact force on the vehicle is detected to be less than 10 kg, an extent of vehicle damage is relatively minor, the vehicle uses one or more ways to remind the passengers of the accident, such as the buzzer, LED lights flashing and seat vibration. The vehicle-mounted system can also remind the passengers to determine whether to send the distress information to the police, the hospital ambulance center and other rescue platforms. The user's experience is improved.

In one embodiment, when the vehicle meets the preset abnormal accident condition, the one or more abnormal state types of the vehicle are determined, the passengers can know specific condition of the vehicle after the abnormal accident. Then the objective rescue plan matched to the abnormal state type of the vehicle is determined. The at least one acoustic reminder device plays the objective rescue plan and the at least one visual reminder device displays the objective rescue plan. When the passengers are frightened and cannot make accurate judgements, the vehicle-mounted system can also remind the passengers to make correct rescue operations. The rescue efficiency and the user's experience are improved.

### A Second Embodiment

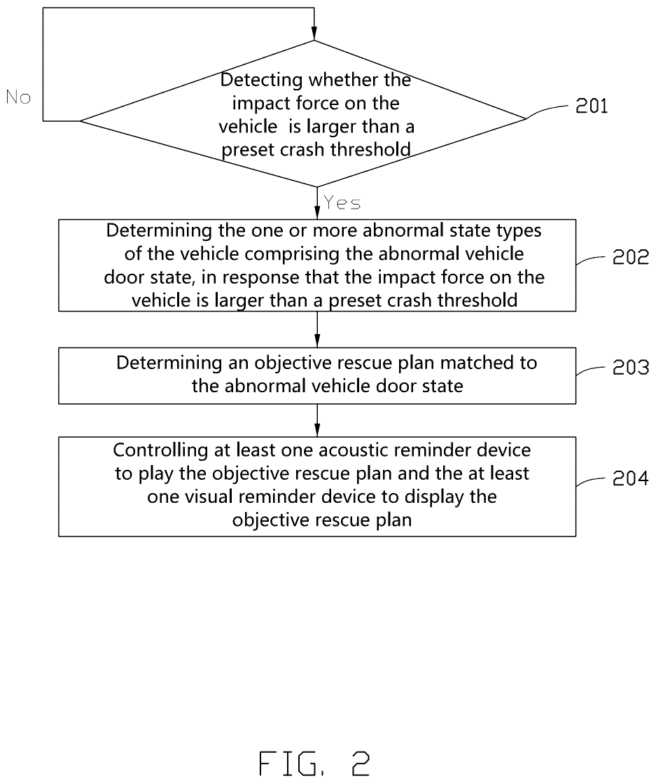

As shown in FIG. 2, the second embodiment is an interpretation of the first embodiment. The second embodiment illustrates specific process of the objective rescue plan, when the state type of the vehicle is the abnormal vehicle door state. The second embodiment is applied to the vehicle-mounted system.

In block S201, it is detected whether the impact force on the vehicle exceeds a preset crash threshold.

In one embodiment, the preset crash threshold can be set as 10 kg. The preset crash threshold can be adjusted according to model of the vehicle or impact location of the vehicle, and so on.

In block S202, the one or more abnormal state types of the vehicle are determined to be the abnormal vehicle door state, in response to the vehicle meeting the preset abnormal accident condition that an impact force on the vehicle is larger than the preset crash threshold.

In block S203, the objective rescue plan matched to the abnormal vehicle door state is determined.

In one embodiment, the objective rescue plan includes broken window location tips, escape tool use tips and escape tool placement tips. The escape tool can be the broken window hammer.

In block S204, the at least one acoustic reminder device is controlled playing the objective rescue plan and the at least one visual reminder device is controlled displaying the objective rescue plan.

In some embodiments, the objective rescue plan includes some blocks. The at least one acoustic reminder device is controlled to repeatedly play a first execution block of the plurality of execution blocks of the objective rescue plan in the vehicle, the vehicle-mounted system detects whether the first execution block is completed in real time. After the first execution block is completed, the at least one acoustic reminder device repeats playing a second execution block of the plurality of execution blocks of the objective rescue plan in the vehicle. When the second execution block is completed in real time to play a next execution block of the plurality of execution blocks of the objective rescue plan, until the last execution block of the plurality of execution blocks of the objective rescue plan is played repeatedly.

For example, the objective rescue plan that matches to the abnormal vehicle door state includes two blocks: (1) the broken window locations and the broken window hammer position tips; (2) using method tips of the broken window hammer. When the one or more impact detection sensors detect that the vehicle has collided, the impact force on the vehicle is transmitted to the vehicle-mounted system. When the vehicle-mounted system detects that the impact force on the vehicle is larger than the preset crash threshold, the buzzer plays the warning sound and the LED lights flash. The vehicle display screen displays all the blocks of the objective rescue plan, the loudspeaker plays the broken window location tips and the broken window hammer location tips, the lights in the vehicle shine on the broken window locations and a broken window hammer location. After the vehicle-mounted system detects the passengers find the broken window hammer, the loudspeaker plays the using method tips of the broken window hammer, until the passengers get out of the vehicle.

### A Third Embodiment

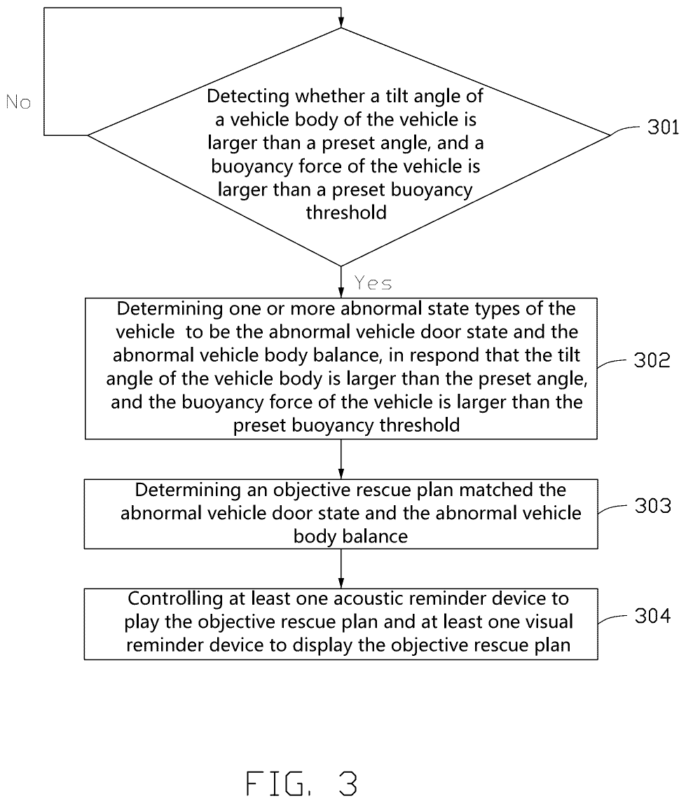

As shown in FIG. 3, the third embodiment is an interpretation of the above embodiments. The third embodiment illustrates the specific process of the objective rescue plan, when the state type of the vehicle is the abnormal vehicle body balance and the abnormal vehicle door state. The third embodiment is applied to the vehicle-mounted system.

In block S301, it is detected whether a tilt angle of a vehicle body of the vehicle is larger than a preset angle, and a buoyancy force of the vehicle is larger than a preset buoyancy threshold.

In one embodiment, the preset angle and the preset buoyancy threshold can be set according to actual needs.

In block S302, when the tilt angle of the vehicle body is larger than the preset angle, and the buoyancy force of the vehicle is larger than the preset buoyancy threshold, the one or more abnormal state types of the vehicle are determined to be the abnormal vehicle door state and the abnormal vehicle body balance.

In block S303, the objective rescue plan matching the abnormal vehicle door state and the abnormal vehicle body balance is determined.

In one embodiment, the objective rescue plan includes the broken window location tips, the escape tool use tips and the escape tool placement tips.

In block S304, the at least one acoustic reminder device is controlled playing the objective rescue plan and the at least one visual reminder device is controlled displaying the objective rescue plan.

For example, the objective rescue plan that marches to the abnormal vehicle door state and the abnormal vehicle body balance includes two blocks: (1) the broken window locations and the broken window hammer position tips; (2) the using method tips of the broken window hammer. When the one or more gyroscope sensors detect that the vehicle tilts, and the one or more buoyancy sensors detect that the buoyancy of the vehicle is abnormal, the tilt angle of the vehicle body of the vehicle and the buoyancy force of the vehicle are transmitted to the vehicle-mounted system. When the vehicle-mounted system detects that the tilt angle of the vehicle body is larger than the preset angle and the buoyancy force of the vehicle is larger than the preset buoyancy threshold, it indicates that the vehicle has fallen into water. The vehicle-mounted system controls the buzzer to play the warning sound and controls the LED lights flashing. The vehicle display screen displays all the blocks of the objective rescue plan, the loudspeaker plays the broken window location tips and the broken window hammer location tips, the lights in the vehicle shine on the broken window locations and the broken window hammer location. After the vehicle-mounted system detects the passengers find the broken window hammer, the loudspeaker plays the using method tips of the broken window hammer, until the passengers get out of the vehicle.

### A Fourth Embodiment

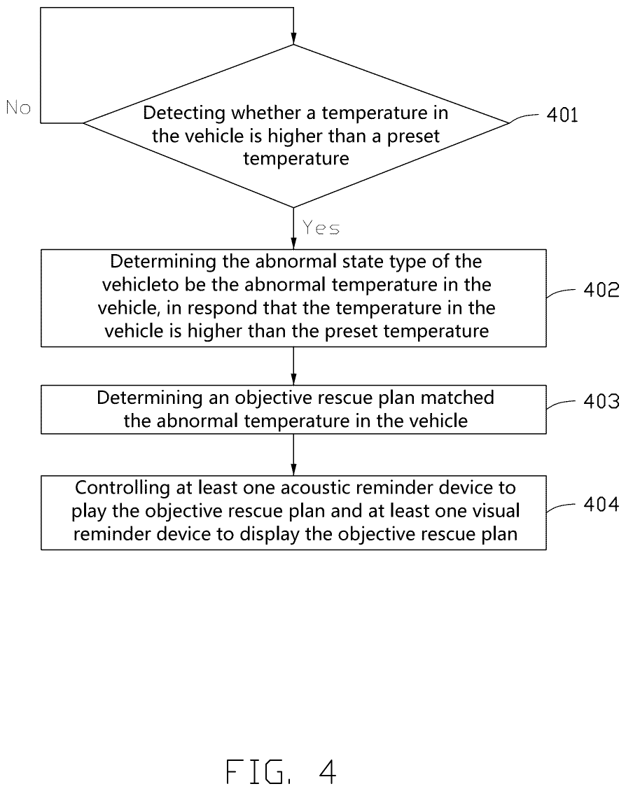

As shown in FIG. 4, the fourth embodiment is an interpretation of the above embodiments. The fourth embodiment illustrates the specific process of the objective rescue plan, when the state type of the vehicle is the abnormal temperature in the vehicle. The fourth embodiment is applied to the vehicle-mounted system.

In block S401, it is detected whether a temperature in the vehicle is higher than a preset temperature.

In one embodiment, the preset temperature can be set according to actual needs.

In block S402, when the temperature in the vehicle is higher than the preset temperature, the abnormal state type of the vehicle is determined to be the abnormal temperature in the vehicle.

In block S403, the objective rescue plan matched to the abnormal temperature in the vehicle is determined.

In block S404, the at least one acoustic reminder device is controlled playing the objective rescue plan and the at least one visual reminder device is controlled displaying the objective rescue plan.

For example, the objective rescue plan that matches the abnormal temperature in the vehicle includes two blocks: (1) flameout tips; (2) get off tips. When the one or more temperature sensors detect that the temperature in the vehicle is abnormal, and the temperature in the vehicle is transmitted to the vehicle-mounted system. When the vehicle-mounted system detects that the temperature in the vehicle is higher than the preset temperature, it indicates that the battery in the vehicle is overheating and catching fire at this time. The vehicle-mounted system controls the buzzer plays the warning sound and controls the LED lights flashing. The vehicle display screen displays all the blocks of the objective rescue plan, the loudspeaker prompts the driver to turn off the vehicle, and after the vehicle is detected to turn off, the loudspeaker prompts the passengers to get out of the vehicle.

### A Fifth Embodiment

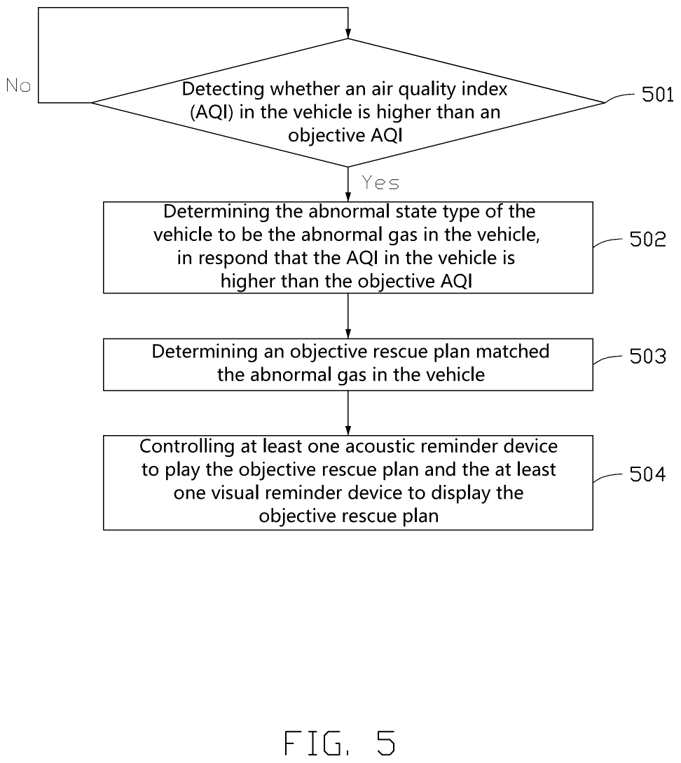

As shown in FIG. 5, the fifth embodiment is the interpretation of the above embodiments. The fifth embodiment illustrates the specific process of the objective rescue plan, when the state type of the vehicle is the abnormal gas in the vehicle. The fifth embodiment is applied to the vehicle-mounted system.

In block S501, it is detected whether an air quality index (AQI) in the vehicle is higher than an objective AQI.

In one embodiment, the objective AQI can be set according to actual needs.

In block S502, when the AQI in the vehicle is higher than the objective AQI or a dangerous gas concentration in the vehicle exceeds a preset concentration, the abnormal state type of the vehicle is determined to be the abnormal gas in the vehicle.

In block S503, the objective rescue plan matched to the abnormal gas in the vehicle to obtain the objective rescue plan.

In block S504, the at least one acoustic reminder device is controlled playing the objective rescue plan and the at least one visual reminder device is controlled displaying the objective rescue plan.

When the one or more gas sensors detect that the AQI in the vehicle is abnormal, or the dangerous gas concentration in the vehicle exceeds the preset concentration, and the AQI in the vehicle is transmitted to the vehicle-mounted system. When the vehicle-mounted system detects that the AQI in the vehicle is higher than the objective AQI, it indicates that the lives of the passengers in the vehicle are in danger. The vehicle-mounted system controls the buzzer to play the warning sound and controls the LED lights to flash. The vehicle-mounted system sends the distress information and the actual location of the vehicle to the police. The display screen displays all the blocks of the objective rescue plan, and the loudspeaker in the vehicle plays the objective rescue plan.

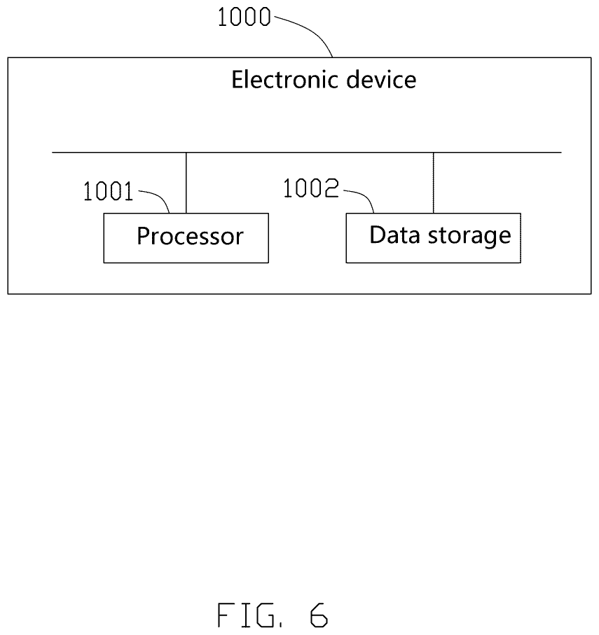

As shown in FIG. 6, one exemplary embodiment of an electronic device 1000 comprises at least one processor 1001 and a data storage 1002. The data storage 1002 stores one or more programs which can be executed by the at least one processor 1001. The data storage 1002 is used to store instructions, and the processor 1001 is used to call up instructions from the data storage 1002, so that the electronic device 1000 performs the steps of the method in the above embodiment.

In one embodiment, a non-transitory storage medium recording instructions is disclosed. When the recorded computer instructions are executed by a processor of an electronic device 1000, the electronic device 1000 can perform the method.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle emergency rescue method applied in a vehicle, the vehicle emergency rescue method comprising:
detecting whether the vehicle meets a preset abnormal accident condition;
in response that the vehicle meets the preset abnormal accident condition, determining one or more abnormal state types of the vehicle, wherein the abnormal state types comprise abnormal vehicle door state, abnormal vehicle body balance, abnormal temperature in the vehicle, and abnormal gas in the vehicle;
in response that the one or more abnormal state types of the vehicle are determined, determining an objective rescue plan matched the one or more abnormal state types of the vehicle; and
controlling at least one acoustic reminder device to play the objective rescue plan and at least one visual reminder device to display the objective rescue plan.

2. The vehicle emergency rescue method of claim 1, wherein in response that the vehicle meets the preset abnormal accident condition, determining the one or more abnormal state types of the vehicle, comprises:
determining the one or more abnormal state types of the vehicle comprising the abnormal vehicle door state, in response that an impact force on the vehicle is larger than a preset crash threshold.

3. The vehicle emergency rescue method of claim 2, wherein the objective rescue plan comprises broken window location tips, escape tool use tips and escape tool placement tips.

4. The vehicle emergency rescue method of claim 1, wherein determining the one or more abnormal state types of the vehicle, in response that the vehicle meets the preset abnormal accident condition, comprises:
determining the one or more abnormal state types of the vehicle comprising the abnormal vehicle door state and the abnormal vehicle body balance, when a tilt angle of a vehicle body of the vehicle is larger than a preset angle, and a buoyancy force of the vehicle is larger than a preset buoyancy threshold.

5. The vehicle emergency rescue method of claim 1, wherein determining the one or more abnormal state types of the vehicle, in response that the vehicle meets the preset abnormal accident condition, comprises:
determining the one or more abnormal state types of the vehicle comprising the abnormal temperature in the vehicle, when a temperature in the vehicle is higher than a preset temperature.

6. The vehicle emergency rescue method of claim 1, wherein determining the one or more abnormal state types of the vehicle, in response that the vehicle meets the preset abnormal accident condition, comprises:
determining the one or more abnormal state types of the vehicle comprising the abnormal gas in the vehicle, when an air quality index (AQI) in the vehicle is higher than an objective AQI or a dangerous gas concentration in the vehicle exceeds a preset concentration.

7. The vehicle emergency rescue method of claim 1, further comprising:
controlling at least one optical reminder device and at least one tactile reminder device to perform an objective reminder action, in response that the vehicle meets the preset abnormal accident condition.

8. The vehicle emergency rescue method of claim 1, wherein the objective rescue plan comprises a plurality of execution blocks;
controlling the at least one acoustic reminder device to play the objective rescue plan comprises:
controlling the at least one acoustic reminder device to repeatedly play a first execution block of the plurality of execution blocks of the objective rescue plan in the vehicle, and detecting whether the first execution block is completed in real time;
controlling the at least one acoustic reminder device to repeatedly play a second execution block of the plurality of execution blocks of the objective rescue plan in the vehicle, when the first execution block is completed; and
detecting whether the second execution block is completed in real time to play a next execution block of the plurality of execution blocks, until the last execution block of the plurality of execution blocks of the objective rescue plan is played repeatedly.

9. An electronic device, comprising:
at least one processor; and
a data storage storing one or more programs which when executed by the at least one processor, cause the at least one processor to:
detect whether a vehicle meets a preset abnormal accident condition;
in response that the vehicle meets the preset abnormal accident condition, determine an abnormal state type of the vehicle, wherein the abnormal state types comprise abnormal vehicle door state, abnormal vehicle body balance, abnormal temperature in the vehicle, and abnormal gas in the vehicle;
in response that the one or more abnormal state types of the vehicle is determined, determine an objective rescue plan matched the one or more abnormal state types of the vehicle; and
control at least one acoustic reminder device to play the objective rescue plan and at least one visual reminder device to display the objective rescue plan.

10. The electronic device of claim 9, wherein the at least one processor determining the one or more abnormal state types of the vehicle, in response that the vehicle meets the preset abnormal accident condition, comprises:
determining the one or more abnormal state types of the vehicle comprising the abnormal vehicle door state, in response that an impact force on the vehicle is larger than a preset crash threshold.

11. The electronic device of claim 10, wherein the objective rescue plan comprises broken window location tips, escape tool use tips and escape tool placement tips.

12. The electronic device of claim 9, wherein the at least one processor determining the one or more abnormal state types of the vehicle, in response that the vehicle meets the preset abnormal accident condition, comprises:
determining the one or more abnormal state types of the vehicle comprising the abnormal vehicle door state and the abnormal vehicle body balance, when a tilt angle of a vehicle body of the vehicle is larger than a preset angle, and a buoyancy force of the vehicle is larger than a preset buoyancy threshold.

13. The electronic device of claim 9, wherein the at least one processor determining the one or more abnormal state types of the vehicle, in response that the vehicle meets the preset abnormal accident condition, comprises:
determining the one or more abnormal state types of the vehicle is the abnormal temperature in the vehicle, when a temperature in the vehicle is higher than a preset temperature.

14. The electronic device of claim 9, wherein the at least one processor determining the one or more abnormal state types of the vehicle, in response that the vehicle meets the preset abnormal accident condition, comprises:
determining the one or more abnormal state types of the vehicle comprising the abnormal gas in the vehicle, when an air quality index (AQI) in the vehicle is higher than an objective AQI or a dangerous gas concentration in the vehicle exceeds a preset concentration.

15. The electronic device of claim 9, wherein the at least one processor is further caused to:
control at least one optical reminder device and at least one tactile reminder device to perform an objective reminder action, in response that the vehicle meets the preset abnormal accident condition.

16. The electronic device of claim 9, wherein the objective rescue plan comprises a plurality of execution blocks;
the at least one processor controlling the at least one acoustic reminder device to play the objective rescue plan comprises:
controlling the at least one acoustic reminder device to repeatedly play a first execution block of the plurality of execution blocks of the objective rescue plan in the vehicle, and detecting whether the first execution block is completed in real time;
controlling the at least one acoustic reminder device to repeatedly play a second execution block of the plurality of execution blocks of the objective rescue plan in the vehicle, when the first execution block is completed; and
detecting whether the second execution block is completed in real time to play a next execution block of the plurality of execution blocks, until the last execution block of the plurality of execution blocks of the objective rescue plan is played repeatedly.

17. A non-transitory storage medium having stored thereon instructions that, when executed by a processor of an electronic device, causes the electronic device to perform a vehicle emergency rescue method, the vehicle emergency rescue method comprising:
detecting whether a vehicle meets a preset abnormal accident condition;
in response that the vehicle meets the preset abnormal accident condition, determining one or more abnormal state types of the vehicle, wherein the abnormal state types comprise abnormal vehicle door state, abnormal vehicle body balance, abnormal temperature in the vehicle, and abnormal gas in the vehicle;
in response that the one or more abnormal state types of the vehicle is determined, determining an objective rescue plan matched the one or more abnormal state type of the vehicle; and
controlling at least one acoustic reminder device to play the objective rescue plan and at least one visual reminder device to display the objective rescue plan.

18. The non-transitory storage medium of claim 17, wherein determining the one or more abnormal state types of the vehicle, in response that the vehicle meets the preset abnormal accident condition, comprises:
determining the one or more abnormal state types of the vehicle comprising the abnormal vehicle door state, in response that an impact force on the vehicle is larger than a preset crash threshold.

19. The non-transitory storage medium of claim 17, wherein determining the one or more abnormal state types of the vehicle, in response that the vehicle meets the preset abnormal accident condition, comprises:
determining the one or more abnormal state types of the vehicle comprising the abnormal vehicle door state and the abnormal vehicle body balance, when a tilt angle of a vehicle body of the vehicle is larger than a preset angle, and a buoyancy force of the vehicle is larger than a preset buoyancy threshold.

20. The non-transitory storage medium of claim 17, wherein determining the one or more abnormal state types of the vehicle, in response that the vehicle meets the preset abnormal accident condition, comprises:
determining the one or more abnormal state types of the vehicle comprising the abnormal temperature in the vehicle, when a temperature in the vehicle is higher than a preset temperature.
